(19) United States
(12) Patent Application Publication
(10) Pub. No.: US 2008/0138471 A1
(43) Pub. Date: Jun. 12, 2008

(54) L-Theanine based chocolate confection

(76) Inventor: David W. Chapman, Redmond, WA (US)

Correspondence Address: DEAN A. CRAINE, SUITE 140, 400 - 112TH AVENUE NE, BELLEVUE, WA, 98004, US

(21) Appl. No.: 11/888,897

(22) Filed: Aug. 1, 2007

Related U.S. Application Data
(60) Provisional application No. 60/835,076, filed on Aug. 1, 2006.

(51) Int. Cl. A23G 3/48; A23G 3/54

(52) U.S. Cl. 426/102; 426/103

(57) ABSTRACT

A confection disclosed herein that includes an outer chocolate layer that enrobes a flavored paste center containing L-Theanine. The flavored paste center contains a fruit paste, enriched natural fruit and dairy flavorings, non-dutched cocoa powder, and a non insulin inducing sugar, such as xylitol or a combination of erithrytol and lo han. The outer chocolate layer consists of a chocolate liquor, cocoa butter, lecithin, and minimal sugar. In the preferred embodiment, the confection is manufactured into small circular pieces that can be distributed in individual plastic packages that can be easily carried in a purse or pocket. A plurality of confection is distributed in a large bag container that can be easily stored in a refrigerator.

This is a utility patent application which claims benefit of U.S. Provisional Application No. 60/835,076 filed on Aug. 1, 2006.

### BACKGROUND OF THE INVENTION

1. Field of the Invention

This invention pertains to food and dietary products containing 1100% pure L-Theanine, and more particular to such food and dietary products that can be orally administered in an edible form.

2. Description of the Related Art

L-Theanine is an amino acid found naturally in the green tea plant. It is believed to be the ingredient attributed to the taste of green tea. In Japan, it is marketed as a nutritional supplement for relaxing and yet alerting the human brain. Because of these two qualities, many tea drinkers believe it has the same stimulatory effect as caffeine yet is more calming.

In addition to these mental benefits, studies have also shown that L-Theanine may increase the antitumor activity of some cancer chemotherapeutic agents. There is also some evidence that L-Theanine may increase human T cell and interleukin production, and act as an anti-oxidant.

Chocolate is made from seeds of the cocao tree, Theobroma cacao. In order to produce chocolate, the seeds must dried and fermented. Later, the seeds are finely ground and heated into a paste, in which sugar is added. The process, called conching, is intended to reduce the size of the particles to produce a smooth texture on the consumer's tongue. After the chocolate has been conched, it is then heat tempered to control the size of cocoa butter crystals formed therein. Because the melting point of chocolate is below human body temperature, chocolate melts in the mouth. It is believed by some that because chocolate melts in the mouth, the act of eating chocolate is more pleasurable.

The health benefits of chocolate have been well studied. Dark chocolate, which contains a high cocoa content, is a rich source of flavonoids and alkaloids, such as theobromine and phenethylene, which are believed to have numerous physiological effects in the body. Unfortunately, because of its relatively high cocoa content, relatively high amounts of sugar must be added to mask its bitter taste. (A 100 gram bar of dark chocolate contains 531 calories). Therefore, most health care professionals do not recommend that their patients consume large quantities of chocolate.

What is needed is a single product that contains sufficient therapeutic amounts of L-Theanine and chocolate that has a relatively low caloric value that is packaged for easy portability.

### SUMMARY OF THE INVENTION

It is an object of the present invention to provide an L-Theanine based confection.

It is another object to provide a chocolate based confection that has a relatively low caloric value.

It is an object to provide a process for manufacturing L-Theanine based chocolate confection.

These and other objects of the invention are met by the confection disclosed therein that includes an outer chocolate layer that enrobes a flavored paste center containing 99 to 100% L-Theanine. The L-Theanine is mixed with a fruit paste and optional natural fruit and dairy flavorings, non-Dutched cocoa powder, and a non-insulin inducing sugar, such as xylitol or a combination of erithrytol and lo han. The outer chocolate layer consists of a chocolate liquor, cocoa butter, lecithin, and minimal sugar combining into an enrobing chocolate considered to be healthy by chocolate experts. In the preferred embodiment, the chocolate liquor is 70% chocolate and non processed or non-Dutched.

The confection is manufactured in small circular pieces that can be distributed in individual plastic packages that can be easily carried in a purse or pocket. In the preferred embodiment, each confection weights approximately 6 grams delivers approximately 125 mg of L-Theanine and 1.5 grams of chocolate layer. The recommended daily therapeutic amount of L-Theanine is 200 mg therefore two confections are taken daily approximately 8 to 12 hrs. apart. In the preferred embodiment, a plurality of pieces of confection is distributed in a large bag container that can be easily stored in a refrigerator.

### DESCRIPTION OF THE DRAWINGS

FIG. 1 is an illustration of the a large bag filled with a plurality of individually wrapped confection

FIG. 2 is a sectional side elevational view of the confection.

### DESCRIPTION OF THE PREFERRED EMBODIMENT(S)

Referring to the accompanying Figs. there is shown a confection 10 containing L-Theanine 20 and dark chocolate 30. By combining these two ingredients 20, 30 into one product, a convenient means for consuming both ingredients is provided.

The confection 10 includes an outer chocolate layer 30 that enrobes a flavored paste center 12 containing L-Theanine 20. The flavored paste center 12 contains a fruit paste carrier. In the preferred embodiment, the fruit paste carrier is a raspberry paste which is sufficiently sweet and acidic to mast the bitter alkaline taste of the cocoa powder. In another embodiment, the strawberry or fig paste may be added to the raspberry paste to enhance the flavor of the raspberry paste. In addition, enriched natural fruit and dairy flavorings, non-dutched cocoa powder, and a non insulin inducing sugar, such as xylitol or a combination of erithrytol and lo han may also be added.

The outer chocolate layer 30 consists of a 70% pure chocolate liquor, cocoa butter, lecithin, and minimal sugar. In the preferred embodiment, the chocolate liquor is non-processed and non-Dutched.

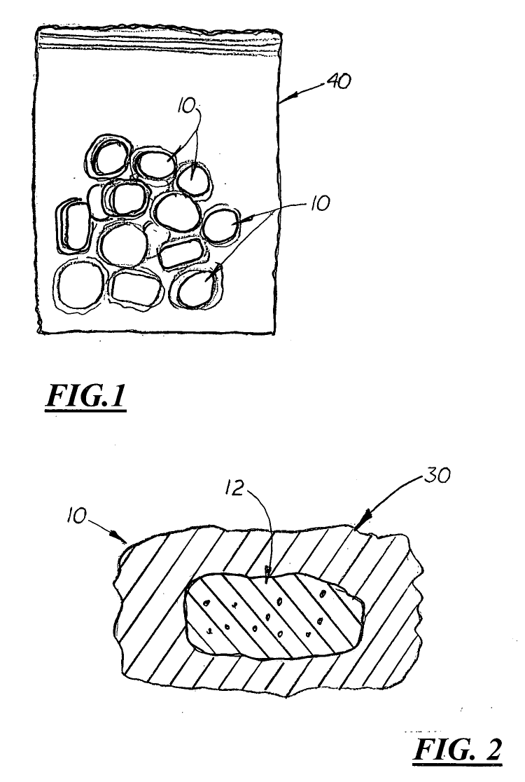

The confection is manufactured in small circular pieces that can be distributed in individual plastic bags 40, as shown in FIG. 1 that can be easily carried in a purse or pocket. In the preferred embodiment, each piece of confection weights approximately 6 grams with the center paste weighing approximately 4.5 grams and the outer chocolate layer 30 weights approximately 1.5 grams. The Center paste contains approximate 125 mgs of 99 to 100% L-Theanine with is available under trademark SUNTHEANINE by Taiyo International Inc. of Edina, Minn. In the preferred embodiment, each center paste contains approximately 125 mg of L-Theanine.

Each piece of confection is individually wrapped and sold with a plurality of pieces of confection in a large bag 40. In the preferred embodiment, the large bag 40 is stored in a refrigerator. Two recommended dose is two pieces of confections daily taken approximately 8 to 12 hours apart.

The below table shows the types and amount of each ingredient used to manufacture 100 pounds of confection:

| 4.5 gram | 33% enrobe | | |
|---|---|---|---|
| center | 1.5 grams | 100 pounds | |
| 24% | Cocoa Powder | 24 | lbs |
| 3% | Coco Butter Buds | 3 | lbs |
| 2% | Cream Plus | 2 | lbs |
| 37% | Fig Paste | 37 | lbs |
| 3.75% | Rasp Juice Concentrate | 3 | lbs 12 Oz |
| 3% | Rasp Juice Flavor | 3 | lbs |
| 17% | Xilitol | 17 | lbs |
| 9.25% | Water | 9.25 | lbs |
| 2% | Active L-Theanine | 2 | lbs |
| 100% | | 100 | lbs Centers |

In compliance with the statute, the invention described herein has been described in language more or less specific as to structural features. It should be understood however, that the invention is not limited to the specific features shown, since the means and construction shown, is comprised only of the preferred embodiments for putting the invention into effect. The invention is therefore claimed in any of its forms or modifications within the legitimate and valid scope of the amended claims, appropriately interpreted in accordance with the doctrine of equivalents.

I claim:

1. A L-Theanine based chocolate confection, comprising:
a. a paste center including 99 to 100 percent L-Theanine and a fruit paste mixed with suitable sweetener;
b. an outer chocolate layer enrobing said paste center.

2. The confection, as recited in claim 1, wherein said fruit paste is a raspberry paste.

3. The confection, as recited in claim 12 wherein said fruit paste also includes a fig paste.

4. The confection, as recited in claim 1, wherein said fruit paste also includes a strawberry paste.

5. The confection, as recited in claim 1, wherein said sweetener is xylitol.

6. The confection, as recited in claim 2, wherein said sweetener is xylitol.

7. The confection, as recited in claim 1, wherein each said confection contains approximately 125 mgs of L-Theanine.

8. The confection, as recited in claim 1, wherein said outer chocolate layer contains approximately 70% non-processed chocolate.
